(19) United States
(12) Patent Application Publication
(10) Pub. No.: US 2003/0026651 A1
(43) Pub. Date: Feb. 6, 2003

(54) Mortise and tenon joint system

(76) Inventor: Duane Ley, St. Cloud, MN (US)

Correspondence Address: Michael S. Neustel, Suite No. 4, 2534 South University Drive, Fargo, ND, 58103, US

(21) Appl. No.: 10/104,189

(22) Filed: Mar. 22, 2002

Related U.S. Application Data
(60) Provisional application No. 60/309,361, filed on Aug. 1, 2001.

(51) Int. Cl. F16B 1/00; B25G 3/36; E04G 7/00

(52) U.S. Cl. 403/401

(57) ABSTRACT

A mortise and tenon joint system for providing miter joints with increased strength and resistance to expansion. The mortise and tenon joint system includes a board member having a first end and a second end, a tenon extending from the first end of the board member, a plurality of channels extending traversely into an outer sidewall of the tenon, and a mortise extending into the second end of the board member having a form similar to the tenon. The tenon includes a base channel, a first channel, a second channel and an end channel. The channels are preferably parallel to one another and preferably completely surround the tenon in a connected manner. The distance between the base channel and the first channel is preferably greater than the distance between the first channel and the second channel.

### CROSS REFERENCE TO RELATED APPLICATIONS

I hereby claim benefit under Title 35, United States Code, Section 119(e) of U.S. provisional patent application Serial NO. ______ (Serial No.) filed on ______ (Filing Date). This application is a continuation of this U.S. provisional application. The U.S. provisional application is currently pending. The U.S. provisional application is hereby incorporated by reference into this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to miter joints and more specifically it relates to a mortise and tenon joint system for providing miter joints with increased strength and resistance to expansion.

2. Description of the Prior Art

Miter joints have been in use for years by wood working professionals. Conventional miter joints are typically utilize dowels, splines, plate jointer biscuits, or mortise and tenons for increasing the overall strength of the miter joint. The mortise is usually a rectangular cavity formed within an end of a piece of material for receiving a tenon. The tenon usually has a structure similar in shape to the mortise. The tenon and the mortise typically have relatively smooth outer and inner walls respectively that are positionable adjacent to one another. An adhesive is typically applied to the mortise and/or tenon with a brush or similar device prior to assembly for securing the tenon within the mortise. The tenon is then positioned within the mortise and the adhesive is allowed to dry thereby securing the tenon within the mortise. Another method of applying adhesive to a mortise and tenon joint is comprised of hydraulically inputting the adhesive between the outer wall of the tenon and the inner wall of the mortise if sufficient clearance exists.

The main problem with conventional mortise and tenon joints is that the adhesive is not completely nor evenly distributed throughout the joint because of the inherent problems of using a hand brushed adhesive. Another problem with conventional mortise and tenon joints is that the usage of a hydraulic distribution of the adhesive within the joints sometimes do not have sufficient clearance thereby possibly causing a “blowout” in the joint resulting in physical damage to the wood. A further problem with conventional mortise and tenon joints is that when hydraulic distribution is utilized, increased clearance is required thereby making it difficult to center the tenon within the mortise. A further problem with conventional mortise and tenon joints is that it is difficult to utilize higher viscosity adhesives which have a higher bond strength, such as polyurethane reactive (PUR). Another problem with conventional mortise and tenon joints is that the lower viscosity adhesives utilized sometimes are undesirably dispersed from the joint onto the outer surface of the wood thereby damaging the appearance of the work piece. Another problem with conventional mortise and tenon joints is that they are labor intensive and not efficient to construct.

While these devices may be suitable for the particular purpose to which they address, they are not as suitable for providing miter joints with increased strength and resistance to expansion. Conventional mortise and tenon joint systems do not provide the desired strength and ease of usage to secure a miter joint.

In these respects, the mortise and tenon joint system according to the present invention substantially departs from the conventional concepts and designs of the prior art, and in so doing provides an apparatus primarily developed for the purpose of providing miter joints with increased strength and resistance to expansion.

### SUMMARY OF THE INVENTION

In view of the foregoing disadvantages inherent in the known types of miter joints now present in the prior art, the present invention provides a new mortise and tenon joint system construction wherein the same can be utilized for providing miter joints with increased strength and resistance to expansion.

The general purpose of the present invention, which will be described subsequently in greater detail, is to provide a new mortise and tenon joint system that has many of the advantages of the miter joint systems mentioned heretofore and many novel features that result in a new mortise and tenon joint system which is not anticipated, rendered obvious, suggested, or even implied by any of the prior art miter joints, either alone or in any combination thereof.

To attain this, the present invention generally comprises a board member having a first end and a second end, a tenon extending from the first end of the board member, a plurality of channels extending traversely into an outer sidewall of the tenon, and a mortise extending into the second end of the board member having a form similar to the tenon. The tenon includes a base channel, a first channel, a second channel and an end channel. The channels are preferably parallel to one another and preferably completely surround the tenon in a connected manner. The distance between the base channel and the first channel is preferably greater than the distance between the first channel and the second channel.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a mortise and tenon joint system that will overcome the shortcomings of the prior art devices.

A second object is to provide a mortise and tenon joint system for providing miter joints with increased strength and resistance to expansion.

Another object is to provide a mortise and tenon joint system that reduces the likelihood of adhesive escaping the joint.

An additional object is to provide a mortise and tenon joint system that allows for the usage of higher viscosity adhesives.

A further object is to provide a mortise and tenon joint system that allow for a snug fit between the mortise and the tenon.

Another object is to provide a mortise and tenon joint system that has a reduced tendency to form gaps.

A further object is to provide a mortise and tenon joint system that can be efficiently assembled.

Another object is to provide a mortise and tenon joint system that allows for even distribution of adhesive throughout the joint regardless of the method of applying the adhesive.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a side view of the present invention illustrating the tenon structure.

FIG. 2 is a top view of the present invention.

FIG. 3 is an upper perspective view of the present invention illustrating the tenon.

FIG. 4 is an upper perspective view of the present invention illustrating the mortise.

FIG. 5 is an exploded upper perspective view of a plurality of board members with respect to one another prior to assembly.

FIG. 6 is a front view of the plurality of board members of FIG. 5 secured together with the tenon and mortise joint.

FIG. 7 is a cutaway view of the tenon positioned within the mortise.

FIG. 8 is a cross sectional view taken along line 8-8 with adhesive applied within the joint.

FIG. 9 is a cross sectional view taken along line 9-9 of FIG. 1 illustrating the mortise structure.

FIG. 10 is a cross sectional view taken along line 10-10 of FIG. 1 illustrating the tenon structure.

### DESCRIPTION OF THE PREFERRED EMBODIMENT

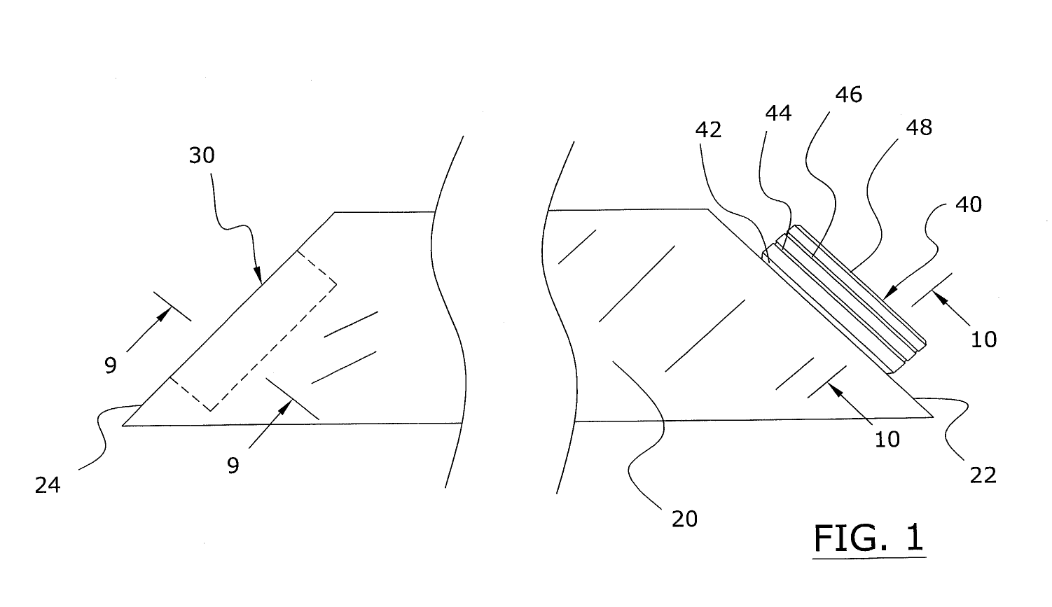

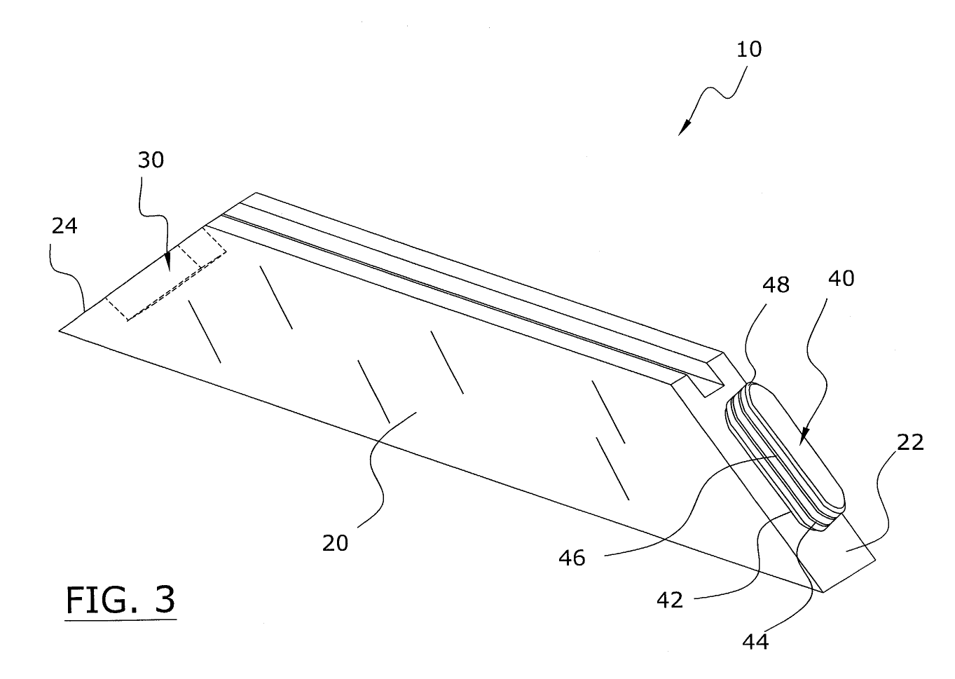

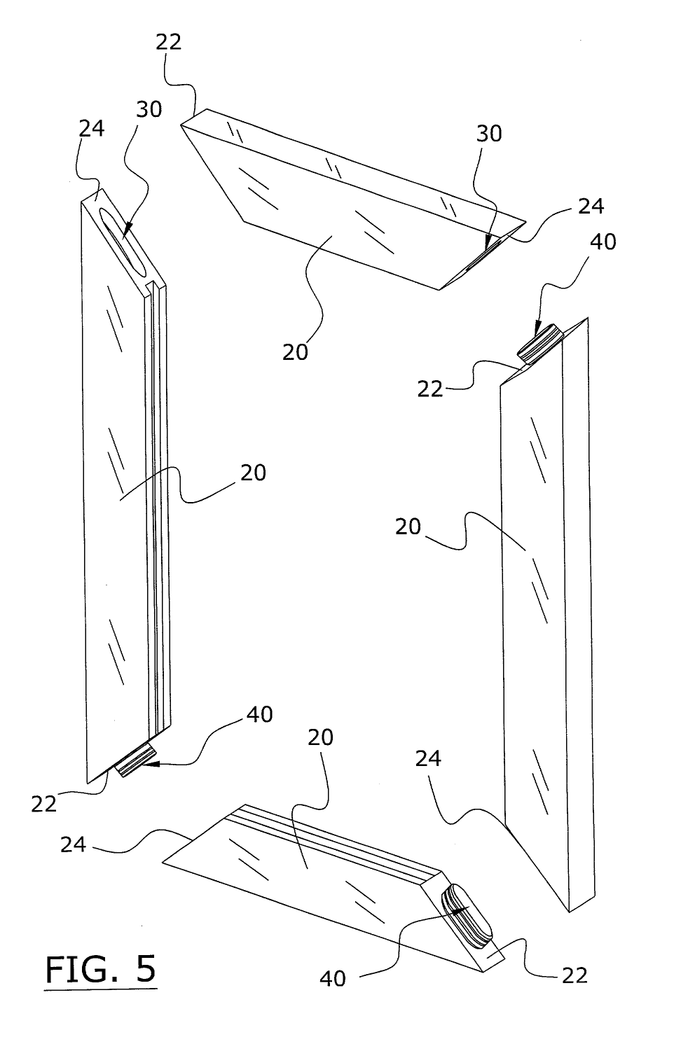

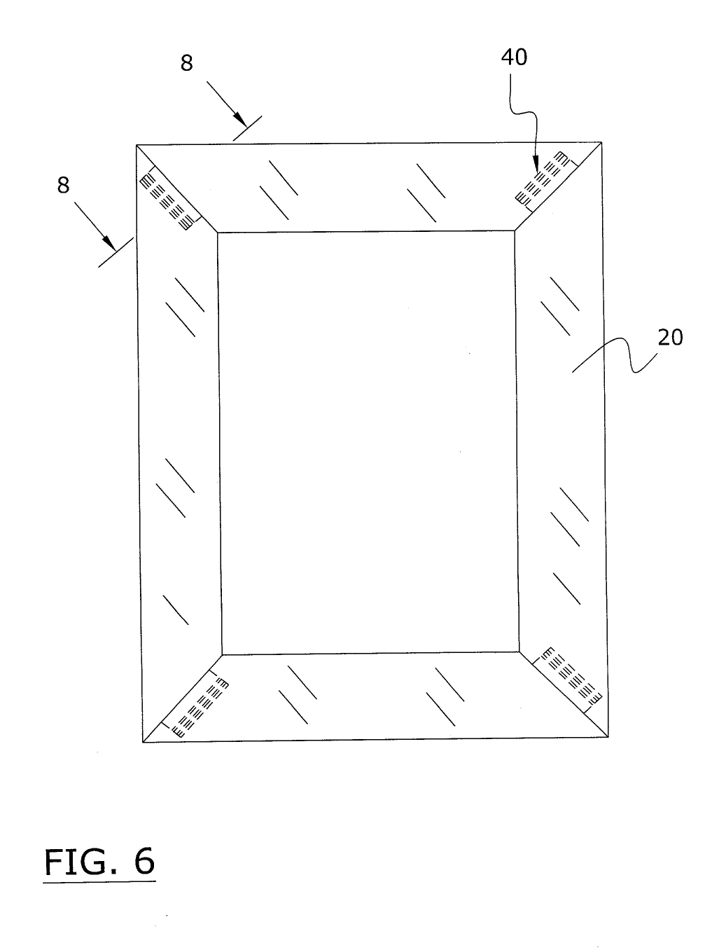

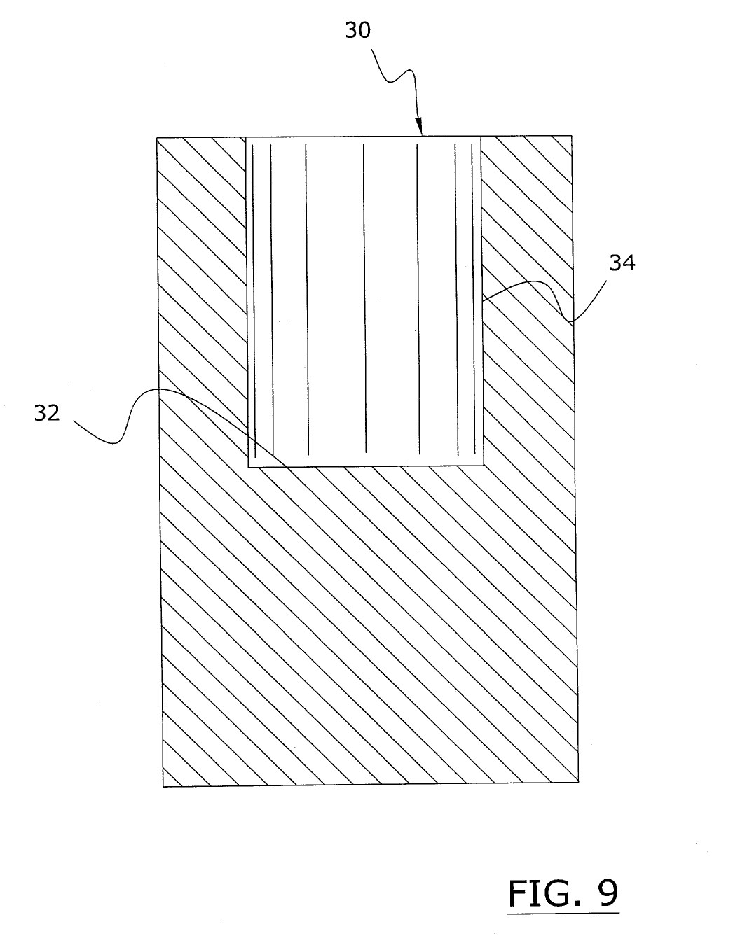

Turning now descriptively to the drawings, in which similar reference characters denote similar elements throughout the several views, FIGS. 1 through 10 illustrate a mortise and tenon joint system 10, which comprises a board member 20 having a first end 22 and a second end 24, a tenon 40 extending from the first end 22 of the board member 20, a plurality of channels 42, 44, 46, 48 extending traversely into an outer sidewall of the tenon 40, and a mortise 30 extending into the second end 24 of the board member 20 having a form similar to the tenon 40. The tenon 40 includes a base channel 42, a first channel 44, a second channel 44 and an end channel 48. The channels are preferably parallel to one another and preferably completely surround the tenon 40 in a connected manner. The distance between the base channel 42 and the first channel 44 is preferably greater than the distance between the first channel 44 and the second channel 44.

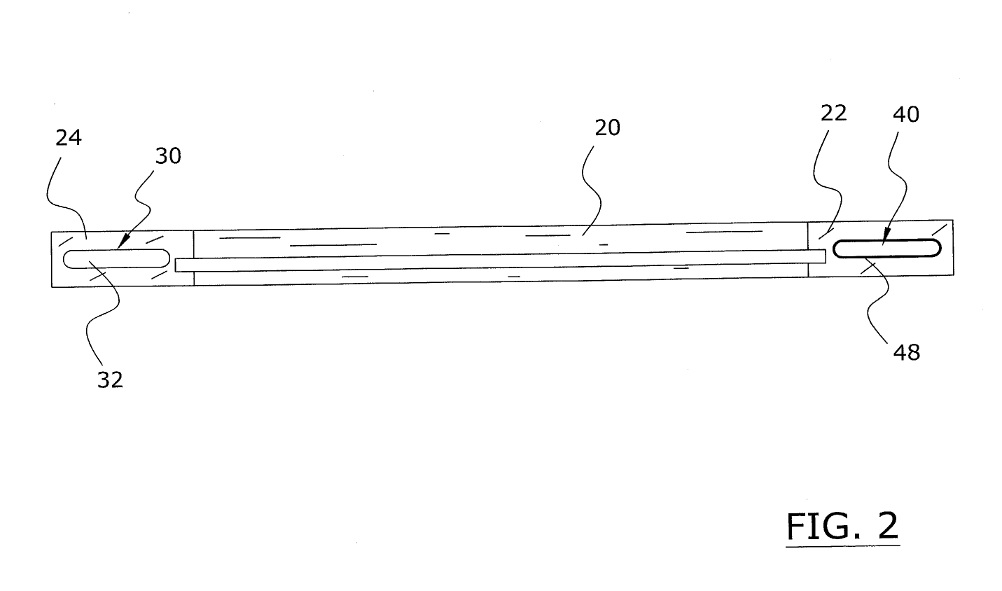

As shown in FIGS. 2 through 6 of the drawings, the board member 20 is comprised of an elongate structure having a first end 22 and a second end 24. The board member 20 may have various lengths, widths and heights as can be appreciated. The board member 20 may be comprised of wood, composite, plastic or other well-known materials. The first end 22 and the second end 24 are preferably angled for mating with a second end 24 and a first end 22 of additional board members 20 respectively. The angles of the first end 22 and the second end 24 may vary depending upon the type of structure desired to be constructed. The exemplary board member 20 illustrated in FIGS. 1 through 6 is merely for illustration purposes only and should not limit the structure of the board member 20 that the present invention may be utilized upon.

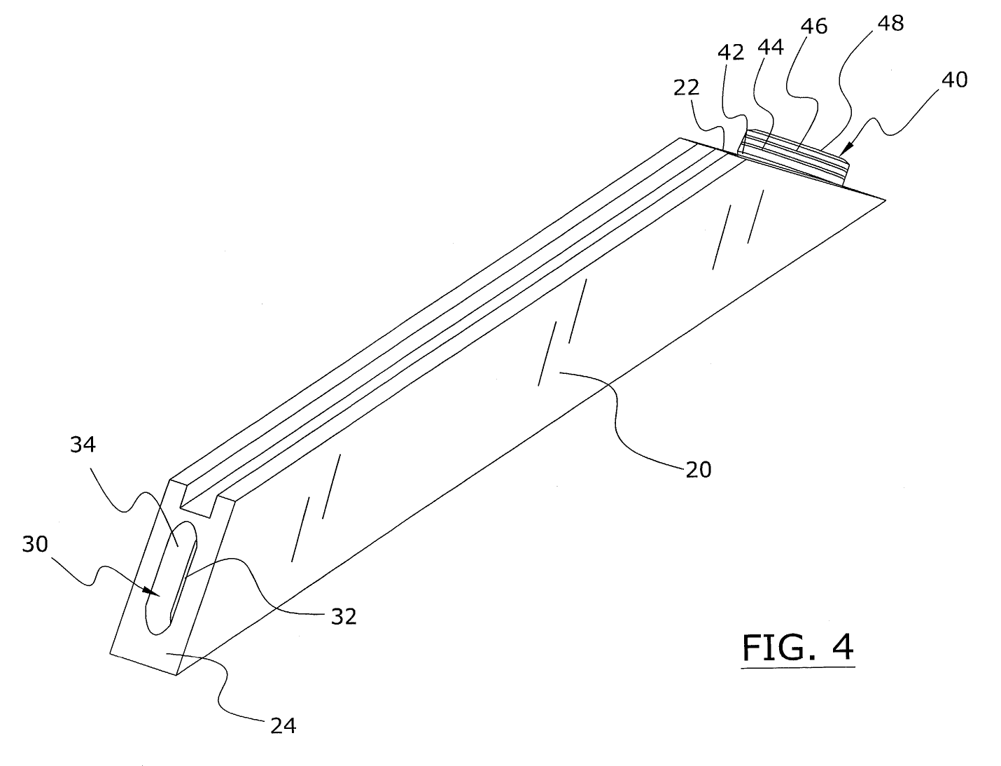

As shown in FIGS. 2, 4 and 9 of the drawings, a mortise 30 extends a finite distance into the second end 24 of the board member 20. The mortise 30 may have various shapes, depths and sizes other than illustrated within the drawings as can be appreciated. The mortise 30 preferably has a floor 32 and at least one inner wall 34. The inner wall 34 of the mortise 30 may be comprised of one or more walls. For example, if a rectangular structure is used to construct the mortise 30, then the mortise 30 will have four inner walls 34. In addition, the inner wall 34 of the mortise 30 may include various shapes including but not limited to an oblong structure with rounded end portions as shown in FIGS. 2 and 4 of the drawings. The mortise 30 may have a circular, rectangular, square, elliptical, triangular, polygonal and other well-known shapes not illustrated in the attached drawings.

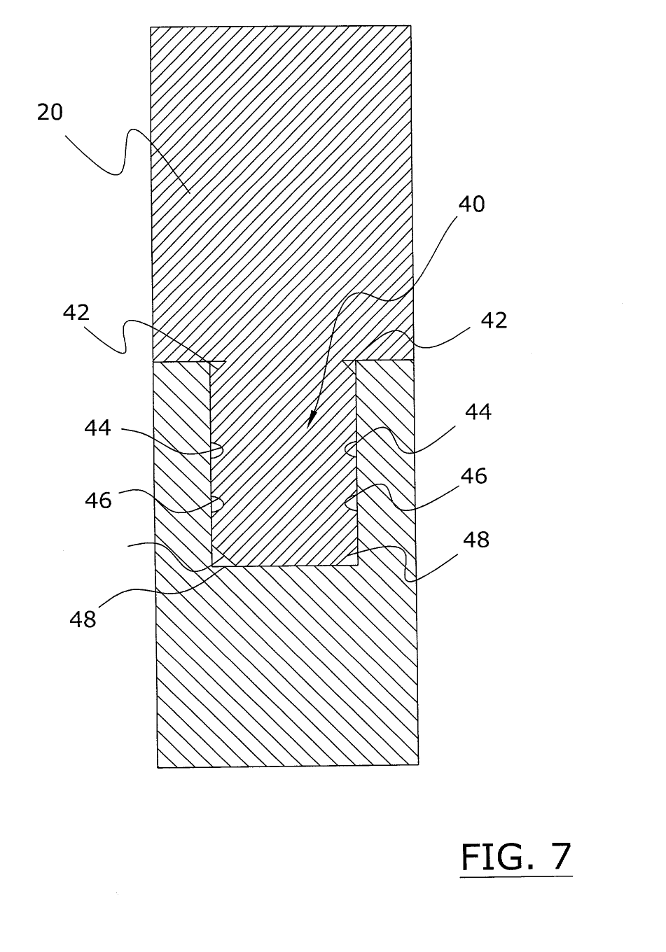

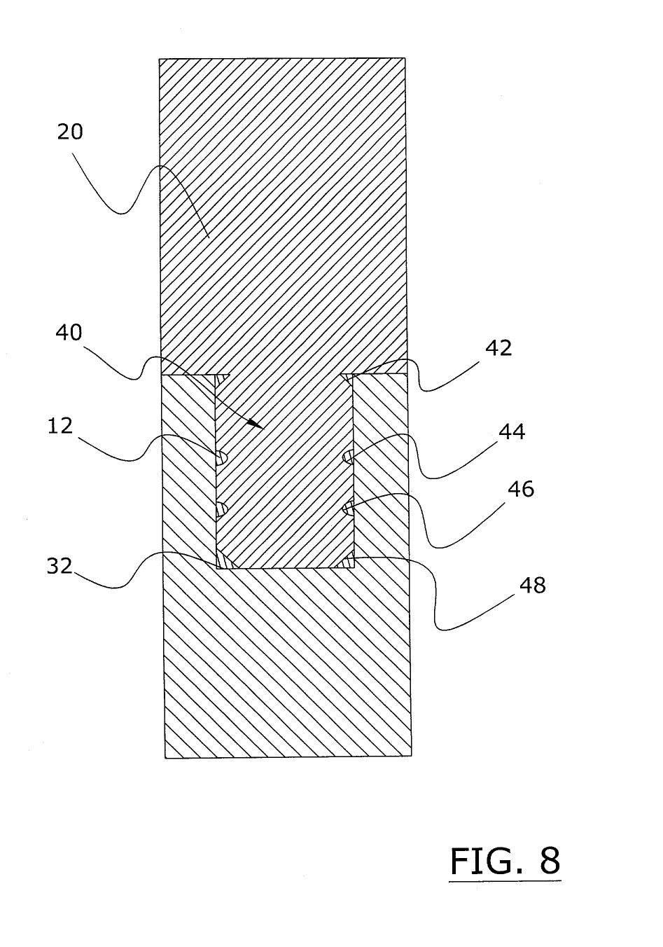

The mortise 30 preferably has a depth sufficient to fully receive the entire length of the tenon 40 as illustrated in FIGS. 7 and 8 of the drawings. The depth of the mortise 30 is preferably slightly greater than the length of the tenon 40 for allowing an amount of adhesive 12 to extend between the distal end of the tenon 40 and the floor 32 of the mortise 30.

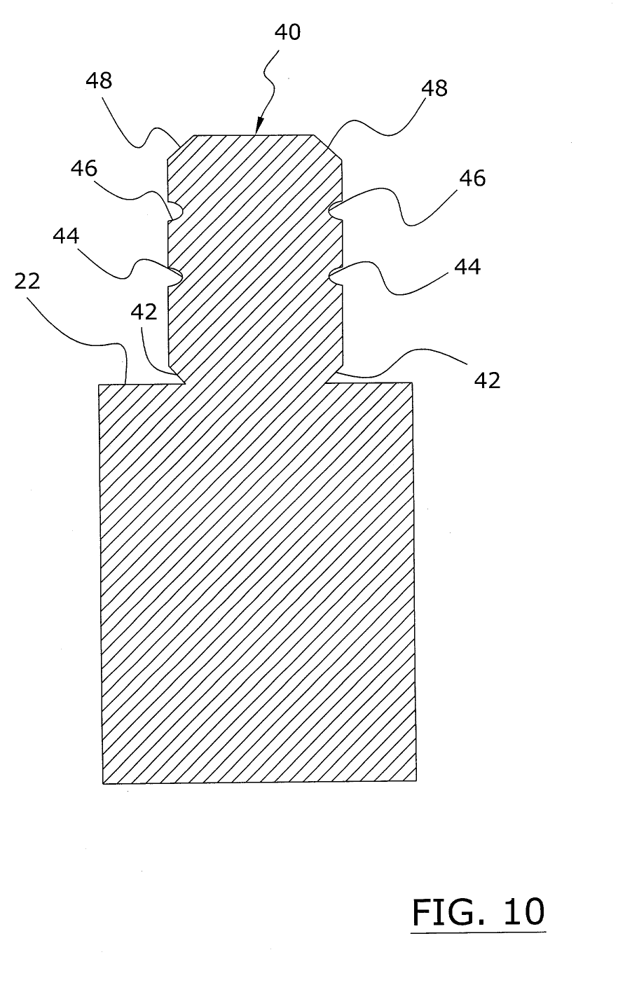

As shown in FIGS. 1, 3, 4 and 5 of the drawings, the tenon 40 extends traversely from the first end 22 of the board member 20 a finite distance. The tenon 40 has at least one outer wall and a distal end. The tenon 40 has a shape and size that corresponds to the shape and size of the mortise 30 to provide a firm fit. The tenon 40 may have various shapes as stated for above for the mortise 30 including but not limited to circular, rectangular, oblong, square, elliptical, triangular, polygonal and other well-known shapes. The figures illustrate the usage of an oblong structure for the tenon 40 with opposing rounded portions that corresponds to the shape of the mortise 30. The tenon 40 preferably has a length equal to or slightly shorter than the depth of the mortise 30 to allow for the distribution of adhesive 12 around the distal end of the tenon 40. As best shown in FIG. 10 of the drawings, the width of the tenon 40 is preferably less than the first end 22 thereby creating a T-structure.

The tenon 40 has a plurality of channels 42, 44, 46, 48 formed or cut within utilizing conventional tools. The channels 42, 44, 46, 48 allow the adhesive 12 to easily pass around the entire perimeter of the tenon 40 to ensure proper coverage of the adhesive 12 regardless of the viscosity of the adhesive 12. The channels 42, 44, 46, 48 may have various shapes such as curved, syncline, square and various other well-known shapes capable of allowing liquid adhesive 12 to pass through. The channels 42, 44, 46, 48 may have various depths other than that illustrated within the attached figures. The number of channels may vary depending upon the board member 20, the type of adhesive 12 used, the type of usage of the joint, and the size of the tenon 40.

As shown in FIGS. 1, 7, 8 and 10 of the drawings, the plurality of channels 42, 44, 46, 48 are preferably comprised of a base channel 42, a first channel 44, a second channel 44 and an end channel 48. The base channel 42 extends into the outer wall at the intersection of the tenon 40 and the first end 22 as best illustrated in FIG. 10 of the drawings. The base channel 42 preferably is comprised of a slanted structured angling toward the first end 22 as further shown in FIG. 10 of the drawings. It can be appreciated that various other shapes may be used for the base channel 42 other than that illustrated in FIG. 10 of the drawings.

The end channel 48 extends within the distal end of the tenon 40 as further shown in FIGS. 1 and 10 of the drawings. The end channel 48 in effect creates a tapered distal end for the tenon 40. A first channel 44 and a second channel 44 extend into the outer sidewall of the tenon 40 between the end channel 48 and the base channel 42. It can be appreciated that more or less channels may be utilized upon the tenon 40 other than illustrated in the drawings.

As shown in FIGS. 1, 3 and 10 of the drawings, the channels are preferably parallel to one another and preferably completely surround the tenon 40 in a connected manner thereby allowing the adhesive 12 to completely surround the tenon 40. The distance between the base channel 42 and the first channel 44 is preferably greater than the distance between the first channel 44 and the second channel 44. The increased distance between the base channel 42 and the first channel 44 provides increased centering of the tenon 40 within the mortise 30 during installation.

The adhesive 12 utilized to secure the tenon 40 within the mortise 30 may be comprised of any well-known adhesive 12 such as but not limited to wood glue or polyurethane reactive (PUR). Many other types of adhesive 12 may be utilized within the present invention to secure the tenon 40 within the mortise 30.

In use, the user may first apply the adhesive 12 within the mortise 30 and/or upon the tenon 40. The user then inserts the tenon 40 within the mortise 30 with the distal end of the tenon 40 entering the mortise 30 initially followed by the main body of the tenon 40. As the tenon 40 is inserted into the mortise 30 in a snug manner, the adhesive 12 is dispersed through the outer surface of the tenon 40 and the inner wall 34 of the mortise 30. Excess adhesive 12 flows through the channels 42, 44, 46, 48 within the tenon 40 into locations that require adhesive 12. After the tenon 40 is fully and snugly seated within the mortise 30, the user then allows the adhesive 12 to dry thereby bonding the tenon 40 within the mortise 30.

Alternatively, the user may hydraulically insert the adhesive 12 between the inner wall 34 of the mortise 30 and the outer wall of the tenon 40 after the tenon 40 is snugly positioned within the mortise 30. As shown in FIG. 7 of the drawings, the tenon 40 is fully positioned within the mortise 30. The user then hydraulically inserts adhesive 12 between the inner wall 34 of the mortise 30 and the outer wall of the tenon 40. The adhesive 12 flows through the channels 42, 44, 46, 48 into all locations between the tenon 40 and the mortise 30. The user continues inserting adhesive 12 until the joint is properly and thoroughly applied with adhesive 12.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A mortise and tenon joint system, comprising:
a first board member having a first end and a tenon extending from said first end;
a second board member having a second end and a mortise within said second end for snugly receiving said tenon; and
a plurality of channels within said tenon for receiving adhesive.

2. The mortise and tenon joint system of claim 1, wherein said plurality of channels are parallel to one another.

3. The mortise and tenon joint system of claim 1, wherein each of said plurality of channels is connected about an outer perimeter of said tenon.

4. The mortise and tenon joint system of claim 1, wherein said plurality of channels are comprised of:
a base channel adjacent said first end;
an end channel within a distal end of said tenon; and
at least one middle channel positioned between said base channel and said end channel.

5. The mortise and tenon joint system of claim 4, wherein said at least one middle channel is located a distance greater from said base channel than from said end channel.

6. The mortise and tenon joint system of claim 5, wherein said at least one middle channel is comprised of a first channel and a second channel.

7. The mortise and tenon joint system of claim 4, wherein said at least one middle channel is comprised of a first channel and a second channel.

8. The mortise and tenon joint system of claim 7, wherein a distance between said first channel and said base channel is greater than a distance between said first channel and said second channel.

9. The mortise and tenon joint system of claim 7, wherein a distance between said first channel and said base channel is greater than a distance between said second channel and said end channel.

10. The mortise and tenon joint system of claim 4, wherein said base channel is comprised of a tapered structure.

11. A mortise and tenon joint system for interconnecting a plurality of board members, comprising:
a first board member having a first end and a second end;
a tenon extending from said first end;
a mortise within said second end; and
a plurality of channels within said tenon for receiving adhesive.

12. The mortise and tenon joint system of claim 11, wherein said plurality of channels are parallel to one another.

13. The mortise and tenon joint system of claim 11, wherein each of said plurality of channels is connected about an outer perimeter of said tenon.

14. The mortise and tenon joint system of claim 11, wherein said plurality of channels are comprised of:
a base channel adjacent said first end;
an end channel within a distal end of said tenon; and
at least one middle channel positioned between said base channel and said end channel.

15. The mortise and tenon joint system of claim 14, wherein said at least one middle channel is located a distance greater from said base channel than from said end channel.

16. The mortise and tenon joint system of claim 15, wherein said at least one middle channel is comprised of a first channel and a second channel.

17. The mortise and tenon joint system of claim 14, wherein said at least one middle channel is comprised of a first channel and a second channel.

18. The mortise and tenon joint system of claim 17, wherein a distance between said first channel and said base channel is greater than a distance between said first channel and said second channel.

19. The mortise and tenon joint system of claim 17, wherein a distance between said first channel and said base channel is greater than a distance between said second channel and said end channel.

20. The mortise and tenon joint system of claim 14, wherein said base channel is comprised of a tapered structure.
